(19) United States
(12) Patent Application Publication
(10) Pub. No.: US 2026/0332087 A1
(43) Pub. Date: Oct. 22, 2026

(54) CONNECTION SYSTEM AND METHOD

(71) Applicants: ElringKlinger Automotive Manufacturing Inc., Southfield, MI (US); ElringKlinger AG, Dettingen/Erms (DE)

(72) Inventors: James Hess, Southfield, MI (US); Gunnar Schaefer, Southfield, MI (US); Thomas Soard, Southfield, MI (US)

(21) Appl. No.: 19/105,970

(22) PCT Filed: Aug. 22, 2023
(86) PCT No.: PCT/EP2023/073070

§ 371 Date: Apr. 18, 2025

Related U.S. Application Data
(60) Provisional application No. 63/399,947, filed on Aug. 22, 2022.

(30) Foreign Application Priority Data
Sep. 16, 2022 (DE) 10 2022 123 867.9

(51) Int. Cl. H02S 30/10; F16B 5/00; F24S 25/67

(52) U.S. Cl. CPC H02S 30/10; F16B 5/0092; F24S 25/67

(57) ABSTRACT

A connecting system for mechanically securing elements or modules, which are positioned adjacent to and adjoining one another in a plane, in particular flat solar modules that are positioned above a supporting surface. In order to produce a connecting system for mechanically securing adjacently positioned elements in a plane with free access to any module for installation and/or removal, it is proposed for a recess composed of two respective half-spaces, which are positioned flush with each other, to be provided in the edge regions of adjacent modules so that in the recess, a securing element with an elongated cross-sectional area can be rotated by approximately 90° around an axis parallel to a surface normal of the modules in order to engage in the half-spaces.

### FIELD OF THE INVENTION

The present invention relates to a connecting system for mechanically securing adjacently positioned elements in a plane, in particular flat solar modules that are positioned above a supporting surface, and to a method for mechanically securing adjacently positioned elements in a plane.

### BACKGROUND OF THE INVENTION

Various approaches are known from the prior the art for mechanically securing, for example, solar modules positioned above a supporting surface, which are even embodied as a pavement and can therefore be driven over by heavy vehicles. For high loads of this kind, it is known to secure each individual element on a supporting surface embodied as a concrete foundation. For elements that are positioned adjacent to one another in a plane, it is less complicated to secure them at their respective adjoining edge regions.

These solar modules are also designed for the road and for loads exerted by heavy vehicles such as trucks. They are placed onto crushed gravel, which is not a perfectly even surface. In order to nevertheless achieve a smooth, even road surface, the modules are connected to one another in the up and down direction perpendicular to a road surface. To achieve this, these connections must be able to transmit the load from one module to the next. A standard solution consists in producing an overlap between adjacent solar modules. This approach, however, has the disadvantage that the solar modules must be laid in a particular sequence and orientation relative to adjacent modules. This also has the disadvantage that the solar modules must be removed in a particular sequence. If it is a large road and only one solar module in a middle region has to be replaced, for example because of a defect, then all of the solar modules positioned in front of it must be removed in order to gain access to and replace the defective module.

The object of the present invention is to produce a connecting system for mechanically securing adjacently positioned elements in a plane with free access to any module for installation and/or removal and also to produce a corresponding method.

### SUMMARY OF THE INVENTION

This object is attained according to the invention by a connecting system for mechanically securing elements or modules, which are positioned adjacently and with their edge regions adjoining one another, in particular flat solar modules that are positioned above a supporting surface, in that recesses are provided in the edge regions of adjacent modules, each comprised of two respective half-spaces that are positioned flush with each other, so that in one of the recesses, a respective securing element with an elongated cross-sectional area can be rotated by approximately 90° around an axis parallel to a surface normal of the modules in order to engage in the half-spaces.

The present invention is based on the realization that in order to achieve an effective securing against an up and down movement between two adjacent modules on a not entirely even supporting surface, it is sufficient for a securing element to protrude from a recess in the edge region of one module into a corresponding recess in the edge region of the adjacent module. Since it is not a feasible option to embody a plug-in connection, at least when releasing a module from a fixed, flat assembly, the securing elements are supported in rotating fashion between the recesses and for this purpose, can be accessed by a tool from one side in order to be rotated into a position in which the securing elements are positioned so that they engage in the respective adjacent half-spaces. The two half-spaces are then coupled to each other by means of a securing element in such a way that they are only able to move together with each other and are no longer able to move relative to each other. The modules are thus connected to one another in the up and down direction perpendicular to a road surface.

Advantageous modifications are the subject of the dependent claims. According to these modifications, the securing element can be inserted into the recess, which is formed by two half-spaces of adjoining modules, from the outside through an opening. The half-spaces are embodied as essentially mirror-symmetrical or point-symmetrical to each other so that the recess is composed of two halves and in a preferred embodiment of the invention, a half-space has a detent lug and/or end stops for limiting a rotation of a securing element to approx. 90°.

In a preferred modification of the invention, the securing element is embodied as block-shaped or prism-shaped. In a top view, therefore, it has a short side and a long side. The short side permits a simple installation between two plates. After being rotated by approx. 90° in the recess, the long side ensures a secure connection between the two plates or modules in that in the securing position, the long side of the securing element is positioned so that it engages in both of the half-spaces.

In particular, the securing element has two circumferential surfaces that constitute circumferential surface segments of a cylinder. An opening associated with the respective securing element into the space between the adjacent modules has an area shape that corresponds to that of the securing element. This type of guide facilitates the insertion of the securing element through the opening into the recess.

In a preferred modification of the invention, the securing element of a connecting system according to the invention is embodied so that it is accessible via a channel in a freely accessible surface of the adjoining edge regions of the adjacent modules for the exertion of a torque.

In an advantageous modification of the invention, the securing element has a recess that is embodied for the engagement of a tool. After the insertion of the securing element into the recess, the tool is in particular used to exert a torque on the securing element. In one embodiment, the recess in the securing element has a keyhole-shaped contour for a secure and captive temporary connection between the tool and the securing element.

The recess in the securing element is advantageously shaped to produce a bayonet connection with the tool. The securing element can thus be affixed to the tool in captive fashion and, like a plug connector, can be not only inserted through the opening into the recess between two modules and rotated, but can also be withdrawn from the recess after a securing connection of the two adjacent module parts has been released.

Preferably, a connecting system according to the invention is embodied and shaped so that on the side opposite from a recess for the engagement of a tool, the securing element has a guide. In one embodiment, this guide is embodied in the form of a pivot pin; alternatively or in addition, the securing element is provided with an external guide, which can be embodied as a protrusion. Recesses correspondingly adapted to the above-mentioned variants of guides are provided in the half-spaces of the modules. The securing element is thus better secured against tilting in the recess in the edge regions of the modules. This also facilitates a rotation of the securing element by means of the tool in the recess. In addition, in the insertion of the securing element into the recess, a limitation or stop is provided at the depth to which the securing element is to be inserted so as to be able to achieve a secure, permanently reliable securing.

In a preferred modification of the invention, a retaining piece is provided, which can be inserted via the securing element, which has been rotated into a securing position, and in particular, can be inserted into the recess through the opening. In an advantageous embodiment, a clamped securing of the retaining piece is provided on or by means of the securing element. Alternatively, one embodiment of the invention provides for the individual retaining pieces, with their function of securing the position of the respective securing elements in predetermined securing positions, to be embodied in the form of protuberances that are integrally incorporated into a covering lip, which covers the channel between the adjacent modules.

As another way to attain the above-mentioned object, a method for securing adjacently positioned elements or modules in a flat arrangement using a device according to the invention according to one or more of the above-mentioned features is proposed in which two modules are loosely laid directly adjacent to one another over a supporting surface, wherein the method advantageously features the fact that a securing element with an elongated cross-sectional area is inserted or introduced through an opening into a correspondingly shaped recess, which is positioned in mirror-symmetrical or point-symmetrical fashion in edge regions of the adjacent modules, and then a respective securing element in the recess is rotated by approx. 90° around an axis parallel to a surface normal of the modules.

The above-indicated features achieve a connecting system that consists of a small number of individual parts, is rugged, and can be actuated quickly and reliably with a minimum of tools. Visual inspections of a securing of adjacent modules performed in a predetermined way are possible as well as functional inspections by means of retaining pieces, which have merely been mechanically placed onto or over securing elements in a particular position using securing elements that are embodied in a predetermined way and can be sufficiently secured in place. Also in this connection, exemplary embodiments will be described in detail based on the drawings.

### BRIEF DESCRIPTION OF DRAWINGS

Other features and advantages of embodiments according to the invention will be explained in greater detail below with reference to exemplary embodiments and based on the drawings. In the schematic depictions in the drawings:

FIG. 1: shows a perspective view of two solar modules, which are mechanically secured to each other in an adjoining edge region by means of several connecting systems;

FIG. 2: shows a perspective view of two progressively cut-away solar modules from the same point of view as FIG. 1;

FIG. 3: shows a partially cut-away perspective, enlarged view III of edge regions of the two solar modules from FIG. 2;

FIGS. 4a-4c: show perspective, partially cut-away views of a securing element and an associated recess in exemplary embodiment A of a connecting system;

FIGS. 5a-5d: show perspective, partially cut-away views of a recess in exemplary embodiment A of a connecting system;

FIGS. 6a and 6b: show perspective, partially cut-away views of a securing element of exemplary embodiment B of a connecting system;

FIGS. 7a to 7c: show sub-steps for producing a connecting system 1 according to exemplary embodiment B in a perspective, partially cut-away view;

FIGS. 8a to 8d: show perspective, partially cut-away views of a recess exemplary embodiment B of a connecting system;

FIGS. 9a and 9b: show a schematically depicted sequence of a disassembly of a connecting system according to exemplary embodiment B;

FIGS. 10a and 10b: show enlarged details from FIG. 3 in order to depict a progressive assembly of an embodiment of a connecting system according to exemplary embodiment B in an edge region;

FIG. 11: shows a partially cut-away, enlarged perspective view XI of edge regions of the two solar modules from FIG. 2; and

FIGS. 12a-12e: show perspective, partially cut-away views of another exemplary embodiment of a covering lip.

### DETAILED DESCRIPTION OF THE INVENTION

The same reference symbols are consistently used for the same elements or method steps throughout the various drawings. Without limiting the invention, all that is shown and described below is one use of a device for securing flat solar modules with a regular hexagonal-edged shape in a highly mechanically resilient way. The solar modules are arranged adjacent to one another on a surface that is generally not entirely flat. However, it is clearly evident to the person skilled in the art that an adaptation to supporting surfaces of any three-dimensional shape is also possible in the same way by using triangular elements in the manner of a finite element mesh in order to achieve a coverage with a predetermined surface shape. The elements or modules themselves can also have a non-planar surface so long as toward adjoining adjacent elements, there are edge regions at which these elements contact one another.

FIG. 1 shows a perspective view of two solar modules 2 with two exemplary embodiments of a connecting system 1 for mechanically securing elements that are positioned adjacent to and adjoining one another. The solar modules 2 are positioned in a plane on a supporting surface 3 and mechanically secured to each other in an adjoining edge region. For this purpose, in the edge regions 4 of the two adjoining modules 2 shown, openings 5 are provided, which are spaced apart from one another at regular intervals. These openings 5 each transition into a recess, which is composed of two respective half-spaces 6, which are positioned flush with each other in the adjacent edge regions 4 of the modules 2. In addition, the half-spaces 6 are embodied as essentially mirror-symmetrical—or in this case point-symmetrical—to each other, as will be further demonstrated in detailed drawings and further described in conjunction therewith. A securing element 7, which is provided with an elongated cross-sectional area Q in order to form a respective connecting system 1, extends through each opening 5 and is supported so that it is able to rotate by approx. 90° in the recess that is composed of two half-spaces 6.

FIG. 1 depicts a mixture of exemplary embodiments A and B of a connecting system 1 for securing two modules 2, which exemplary embodiments will be separately described in greater detail below. In both cases, the securing elements 7 are able to rotate by approx. 90° around an axis M parallel to a surface normal N of the modules 2 in the recess, which is respectively composed of two half-spaces 6, as indicated in FIG. 1 in conjunction with a tool W. For this purpose, the securing elements 7 are embodied as block-shaped or prism-shaped and have two circumferential surfaces that constitute circumferential surface segments of a cylinder. The securing elements 7 are thus able to rotate freely in the respective recesses while making maximum use of the available space.

In both of the depicted exemplary embodiments A and B of the connecting system 1, the securing elements can each be inserted in plug fashion from a free external space through the opening 5 and into the recess. In this case, each of the openings 5 corresponds to a cross-sectional area Q of an associated securing element 7. By means of its outer contour, the securing element 7 performs a relative positioning of the adjoining solar modules 2 in relation to each other and thus makes it easier to position the solar modules 2 relative to each other. In both of the exemplary embodiments A and B, the respective recess is composed of two essentially point-symmetrically shaped half-spaces 6 of adjoining modules 2 and the half-spaces 6 have end stops 8, which will be depicted with greater enlargement in the subsequent detail view, in order to limit a rotation of a securing element to approx. 90° in the cavity and also have detent lugs that are not shown in detail here and that serve to secure the securing elements 7 in a locked position. Now, the longer side of the securing element 7 engages in a securing, force-coupling, and position-coupling way in the half-spaces 6 of the directly adjacent solar modules 2.

In the exemplary embodiment from FIG. 1, a series of the two exemplary embodiments of connecting systems 1 are used in an A-B-A pattern. It is naturally also possible to use only one of the exemplary embodiments A or B of the connecting system 1 in all of the edge regions 4 of the adjacent modules 2 in order to ensure a reliable securing.

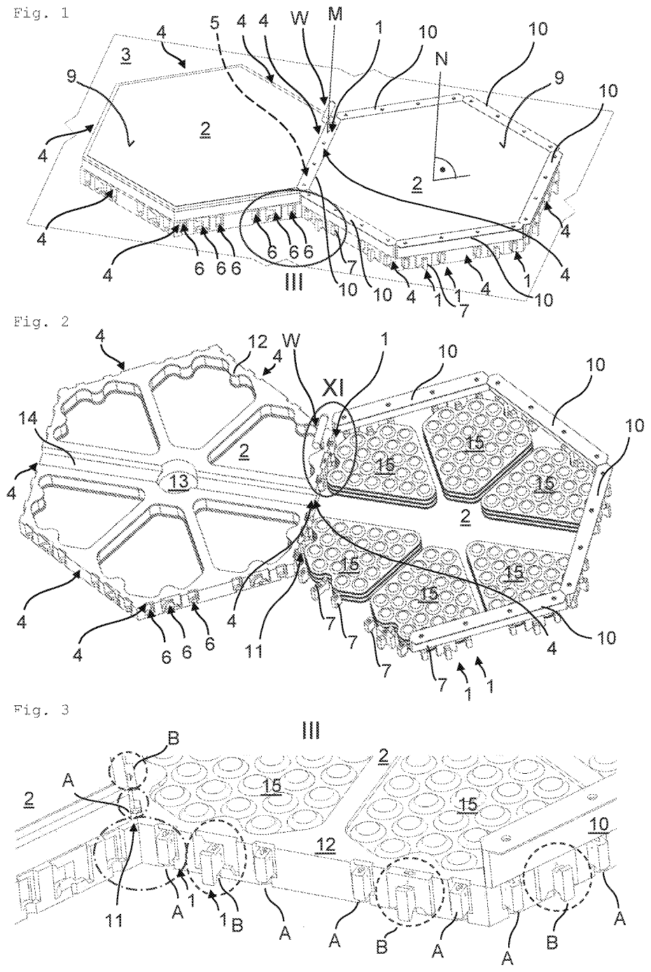

FIG. 2 shows a perspective view of two progressively cut-away solar modules 2 with an approximately hexagonal basic structure from the same point of view as FIG. 1. In addition to a covering layer 9—which in the case of the solar modules 2 shown here, in addition to a highly mechanically resilient protective layer, has underlying functional elements, for example in the form of solar cells and LED elements, heating pads for electrically heating modules 2 in case of snow and ice, as well as sensors for pressure and temperature, etc.—in two edge regions 4, covering lips 10 made of an elastomer material have been removed, which together with these covering layers 9 precisely fill and seal a channel 11 between the covering layers 9 of adjacent modules 2. The module 2 on the left in FIG. 2 has been reduced to a solid chassis 12, into whose edge regions 4 are formed the half-spaces 6, respectively embodied according to exemplary embodiment A or B of the respective connecting systems 1. The chassis 12 can be made of a plastic or aluminum, but in order to compensate for irregularities in the supporting surface 3 it is preferable for the chassis 12 to be made of an elastomer or rubber-elastic plastic. In addition, this chassis 12 is provided with a central receptacle 13 for a set of electronics, which in a real use is connected to adjoining modules 2 via a channel 14 for power and data lines.

All other components have been removed from the module 2 on the right except securing elements 7 corresponding to the exemplary embodiments A or B of the respective connecting systems 1, heat sinks 15 composed of aluminum beaded plates that are stacked on top of one another in mirror-symmetrical fashion to dissipate heat from the solar cells positioned above them, and four of the six covering lips 10 that are inserted to protect the underlying connecting systems 1 from contamination. The stacked aluminum beaded plates are used on the one hand to dissipate heat from a flat set of electronics positioned above them and thus particularly increase an efficiency of solar cells. By dissipating heat from powerfully heated components or regions of the electronics, the heat sinks 15 also reduce the tendency for hot spots to form. Because of a rapid increase in the probability of failure associated with the temperature, this reduction in hot spots increases an average service life of electronic components without requiring a deliberate oversizing of the electronic components used in order to take into account the higher temperatures in the event of high loads. It is also unnecessary to provide any redundancy of components, allowing savings to be achieved with regard not only to costs, but also to installation space. Another function of the heat sinks 15 is that they are very pressure-stable and are thus able to withstand powerful loads due to contact forces. When subjected to a load, for example due to a vehicle rolling over the solar modules, the highly mechanically resilient protective layer, together with underlying functional elements, is mechanically supported on the heat sinks 15 instead of the respective chassis 12.

FIG. 3 shows a partially cut-away perspective view III of edge regions 4 of the two solar modules 2 from FIG. 1 with both the covering lip 10 and the covering layer 9 of the module 2 removed. In this case, the arrangement of the exemplary embodiments A and B of the connecting systems 1 with their corresponding half-spaces 6 in the edge regions 4 is clearly visible.

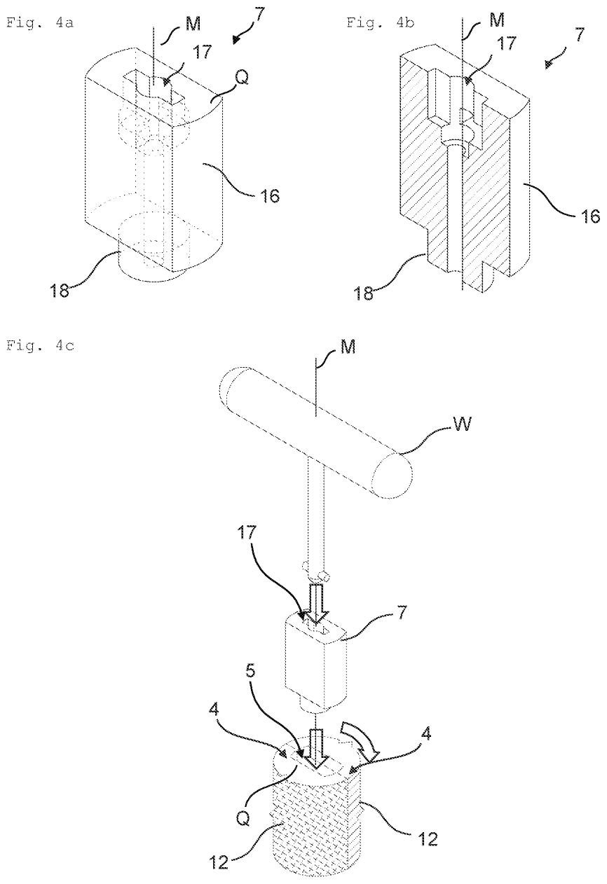

The drawings in FIGS. 4a-4c show perspective, partially cut-away views of a securing element 7 of exemplary embodiment A of the connecting system 1 with an associated recess. FIG. 4a shows that the securing element 7 is embodied as prism-shaped, has a shorter side and a longer side, and has two circumferential surfaces 16, which constitute circumferential surface segments of a cylinder. An approximately keyhole-shaped opening in a free outer surface, which is embodied as a bayonet receptacle 17 or socket in the securing element 7 constitutes a counterpart for the tool W, in order to be able to achieve a simply and quickly producible and releasable mechanical insert-and-turn securing underneath the keyhole in two quarter-circle recesses for transmitting linear forces as well as a torque. This enables a reliable insertion and securing as well as a release upon withdrawal of a respective securing element 7 through the cooperation of the bayonet receptacle 17 and the tool W. The longitudinal section in FIG. 4b shows a specific internal structure of the securing element 7, which in this case can be manufactured as an injection molded part made of plastic or metal.

An assembly and locking procedure is shown with sub-steps indicated by arrows in FIG. 4c: the securing element 7 with an elongated cross-sectional area Q is inserted or plugged through the opening 5 into the recess, which consists of half-spaces 6 that are positioned point-symmetrically to each other in edge regions 4 of the chassis 12 of two adjacent modules 2. Then the tool W is inserted into the recess 17 of the securing element 7 and pushed in until it has been fully inserted when it reaches an end position and the tool W is then rotated in the recess of the half-spaces 6 by approx. 90° around the axis M parallel to a surface normal N of the modules 2. The tool W can also have been inserted into the bayonet opening 17 already as an aid during the insertion of the securing element 7. In any case, the tool W is detached again by rotating it by approx. −90° in the recess 17 of the securing element 7 and can be withdrawn from the securing element 7. This connecting system 1 therefore produces a securing of two modules to each other in a sufficiently mechanically resilient way, which is mechanically reinforced by adjacent connecting systems 1.

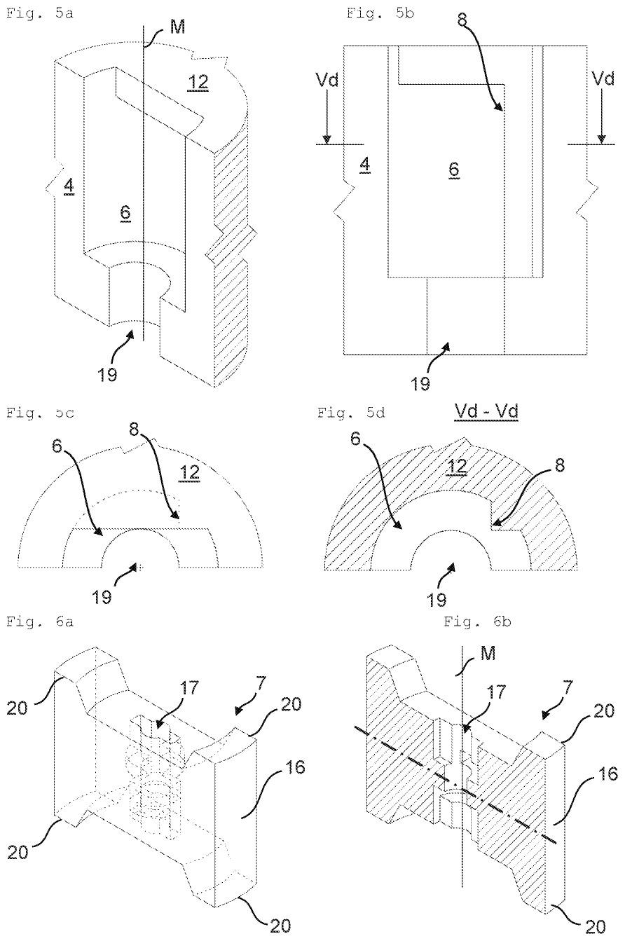

A guide 18 in the form of a pin or ring is formed onto the securing element 7 at the end opposite from the bayonet receptacle 17, as can be seen in FIGS. 4a, 4b. The sequence of FIGS. 5a-5d shows perspective, partially cut-away views of a half-space 6 of a recess of exemplary embodiment A of the connecting system 1. In this case, the shoulder 8, which serves as an end stop for the securing element 7 in the half-space 6 of the recess, is visible in FIGS. 5b-5c. In addition, the half-space 6 of the recess of exemplary embodiment A has a recess 19, in which the guide 18 of the securing element 7 in the form of a pin or ring engages in rotary fashion. This recess also functions as an end stop when the securing element 7 is being inserted into the recess formed by the half-spaces 6. In this simple design, the securing element 7 is thus guided by the circumferential surfaces 16 and the guide 18 in rotatable fashion in the recess until it reaches a predetermined position.

FIG. 6a und 6b respectively show a perspective depiction and a cut-away depiction of a securing element 7 of exemplary embodiment B of the connecting system 1. This securing element 7 is significantly larger than the comparatively more simply embodied securing element 7 described above in connection with exemplary embodiment A. In addition, this securing element 7 is characterized in that it is embodied as mirror-symmetrical in relation to two axes, wherein the second axis extends perpendicular to the central axis M. Instead of a guide 18 of the securing element 7 in the form of a pin or ring, in this case, protrusions 20 are provided as external guides of the securing element 7. The above-depicted symmetry provides four external guides on the securing element 7 of exemplary embodiment B.

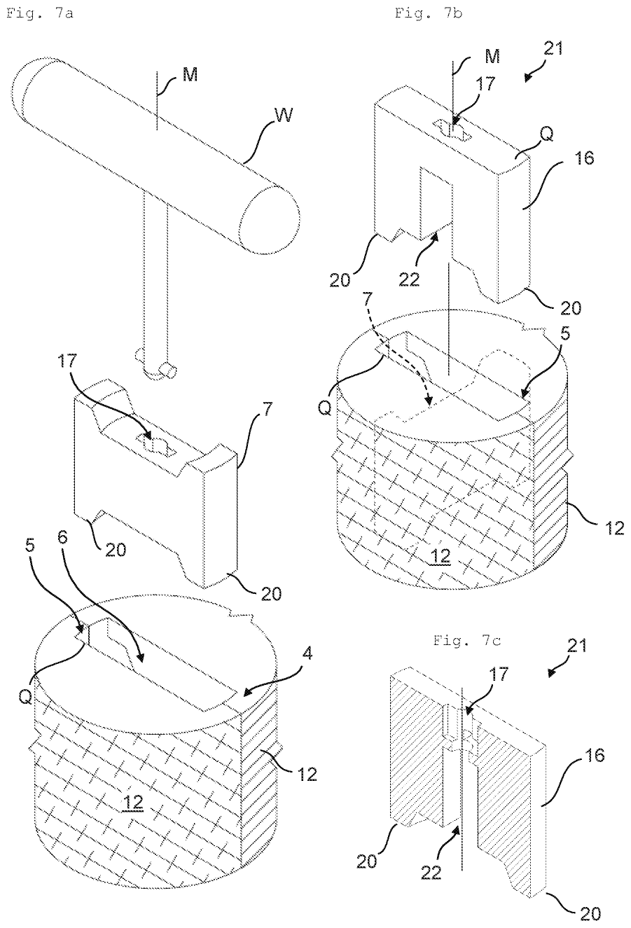

FIGS. 7a to 7c show sub-steps for producing a connecting system 1 according to exemplary embodiment B in a perspective, partially cut-away view. According to FIG. 7a, the securing element is inserted through the opening 6 into the half-spaces 6 as described above in connection with FIG. 4 c. After the removal of the tool W, in this case, a retaining piece 21 is then inserted into the opening 5, as shown in FIG. 7b. The retaining piece 21 has a clamping groove 22, which fits around the securing element 7 in its locked position. At the same time, the retaining piece 21 flatly fills the opening 5 so that it is not possible for the retaining piece 21 to rotate in the opening 5 and it is thus also not possible for the securing element 7 to rotate in the recess.

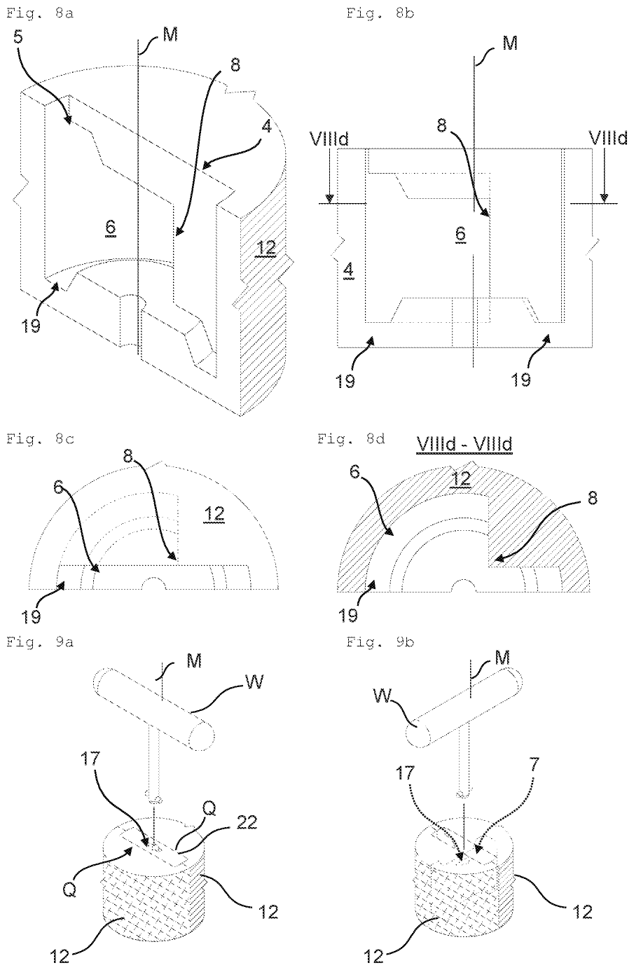

FIGS. 8a to 8d are perspective, partially cut-away views of a recess in edge regions 4 of two chassis 12 of the connecting system 1 according to exemplary embodiment B. The depictions have been selected to be analogous to the sequence of drawings in FIGS. 4a to 4d. A direct comparison of the dimensions of the half-spaces 6 of the two exemplary embodiments A and B clearly shows that in exemplary embodiment B, the half-space 6 has also been appropriately enlarged in accordance with a wider securing element 7. As a recess 19 in the half-space 6 for the guide 18 in the recess, now a kind of rotating assembly is provided in the recess 6, in which the protrusions 20 on the securing element 7 engage in sliding and rotating fashion. Once again, a shoulder 8 functions as an end stop for the rotating movement of the securing element 7.

FIGS. 9a and 9b schematically depict a disassembly of a connecting system of type B. As shown in a cut-away depiction in FIG. 7c, above the clamping groove 22, the retaining piece 21 likewise has a bayonet receptacle 17, which also facilitates insertion of the retaining piece 21 when producing the clamped connection between the clamping groove 22 and the securing element 7 that has already been rotated into the locked position through the use of the tool W. In any case, the bayonet receptacle 17 in the retaining piece 21 and in the securing element 7 facilitates and thus reliably enables a release of the connecting system 1 according to exemplary embodiment B. A securing and releasing of the tool in the bayonet receptacle 17 in all of the above-described elements always follows the same pattern with securing by means of a rotation by approx. 90° and releasing by means of a rotation by approx. 90° in the opposite direction. Aside from this rugged and simply embodied tool W, no other tools are required.

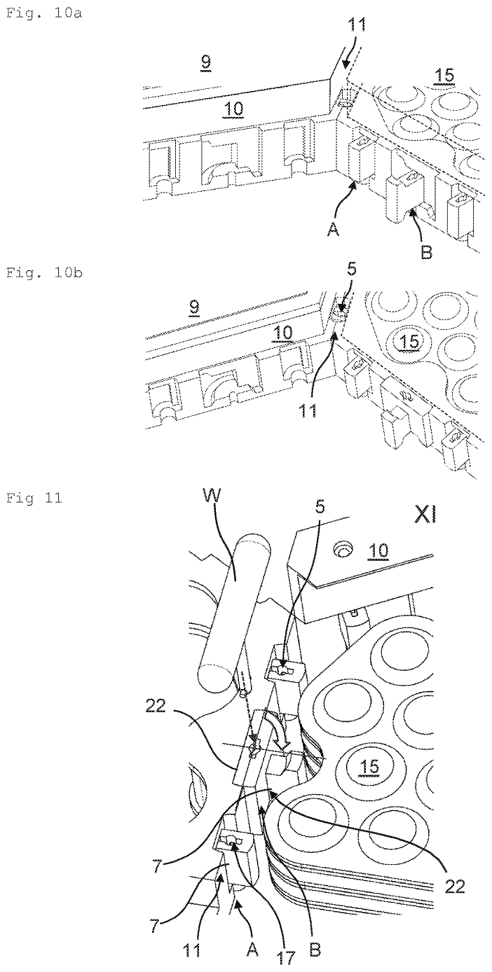

FIGS. 10a and 10b depict enlarged sections from FIG. 3 in order to show a progressive assembly of an embodiment B of a connecting system 1 in an edge region 4. In addition to half-spaces 6, the drawing in FIG. 10a also shows two connecting systems 1 of exemplary embodiment A in their securing positions. In addition, it also shows one half-space 6 and one connecting system 1 of exemplary embodiment B in a securing position. In FIG. 10b, the securing element 7 is also secured in its locked position by a retaining piece 21 that prevents it from being released by turning.

In a partially cut-away perspective view XI of edge regions 4 of the two solar modules 2 from FIG. 2, FIG. 11 shows the quite simply and ruggedly embodied tool W for assembling and disassembling the connecting system 1 in the manner described above, which is indicated here merely by means of a 90° arrow. The openings 5 provided at the bottom of the channel 11 between covering layers 9 of adjacent modules 2, see FIG. 10a, are protected from environmental influences by a covering lip 10, which as an element made of a rubber-elastic elastomer also provides a longitudinal and transverse compensation between the solar modules 2. In addition, these covering lips 10 consisting of an elastomer are inserted into the respective channels 11 and, by means of securing elements that are only schematically indicated here in the bayonet receptacles 17 of the securing elements 7 of the first exemplary embodiment A, are fastened to prevent them from sliding, slipping out, or falling out. Screws can be used for this purpose as well as securing elements with a bayonet receptacle comparable to that of the securing elements 7 and retaining pieces 21 so that they can be actuated by means of the tool W.

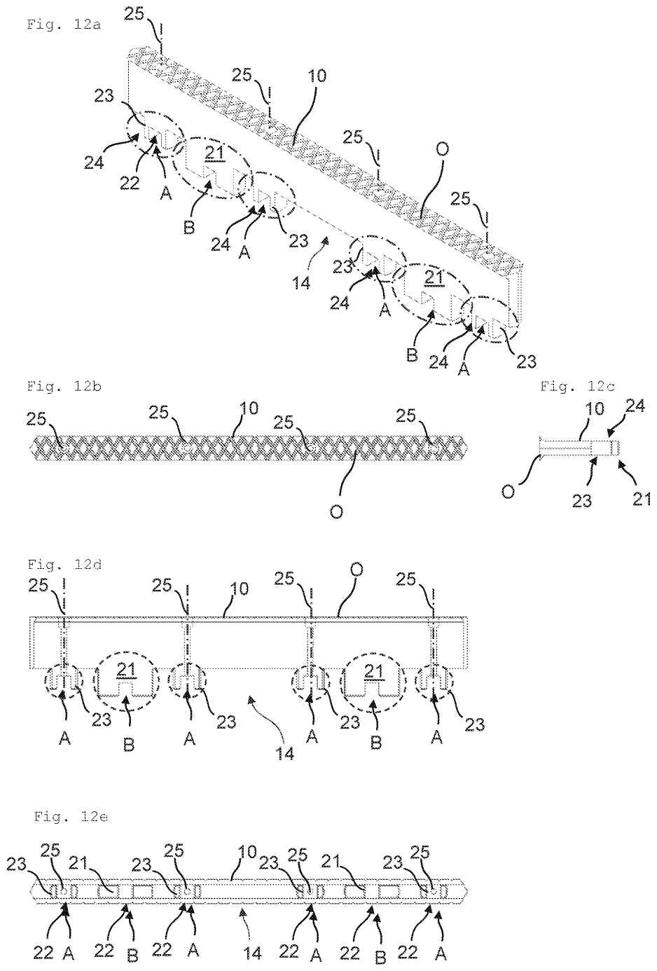

The drawings in FIGS. 12a-12c are a perspective depiction and views of another exemplary embodiment of a covering lip 10, which in an installation position, covers the channel 11 between covering layers 9 of adjacent modules 2 and overlaps the channel 14 for power and data lines extending between the modules 2. The covering lip 10 has a corrugated open surface O, also see FIG. 12b. By contrast with the cross-sectionally T-shaped covering lip 10 shown in the drawing in FIG. 2 among others, here, not only are recesses provided for securing the position of the covering lip 10 by means of screw-connections to securing elements 7 in modified bayonet receptacles 17 of the connecting system 1 according to exemplary embodiment A extending through recesses in the covering lip 10. But also, retaining pieces 21 of exemplary embodiment B and corresponding retaining pieces 23 for connecting systems 1 of exemplary embodiment A are provided, likewise with a clamping groove 22. Both types of retaining pieces 21, 23, as rotation prevention means for the respective securing element 7, are embodied in the form of protuberances 24 that are integrally formed onto the rubber-elastomer covering lip 10. This reduces the number of individual parts to be separately manipulated and inserted in the respective locations, which also reduces the amount of time required for installing or removing a module 2.

The front view of FIG. 12c shows a now essentially Y-shaped covering lip 10. The protuberances 24 for forming the retaining pieces 21, 23 are of different depths, as also depicted in FIG. 12d in a side view showing openings 25 for the securing by means of screw connections. FIG. 12e enhances the depiction by providing a view from underneath. This drawing also shows that in this exemplary embodiment, openings 25 for the securing by means of screw connections for the covering lip 10 are only provided between the comparatively small and narrow retaining pieces 23. A clamping by means of the retaining pieces 21 is considered to be sufficient so that additional screw connections at their locations are omitted.

1. A connecting system for mechanically securing elements or modules, which are positioned adjacently and with their edge regions adjoining one another in a plane, the connecting system comprising:
a recess in the edge regions of adjacent elements or modules, and
a securing element with an elongated cross-sectional area,
wherein the recess is composed of two respective half-spaces that are positioned flush with each other so that in the recess, the securing element can be rotated by approximately 90° around an axis parallel to a surface normal to the elements or modules in order to engage in the two half-spaces.

2. The connecting system according to claim 1, wherein the securing element can be inserted in plug fashion into the recess from an outside through an opening, wherein the two half-spaces of which the recess is composed are two essentially point-symmetrically or mirror-symmetrically shaped half-spaces of adjacent elements or modules.

3. The connecting system according to claim 1, wherein the securing element is block-shaped or prism-shaped, and has a shorter side and a longer side.

4. The connecting system according to claim 1, wherein the securing element accessible via a channel in a freely accessible surface of the adjoining edge regions of the adjacent elements or modules for exertion of a torque.

5. The connecting system according to claim 1, wherein the securing element has a recess that is embodied for an engagement of a tool.

6. The connecting system according to claim 5, wherein the recess in the securing element has a keyhole-shaped contour.

7. The connecting system according to claim 6, wherein the recess in the securing element is shaped to produce a bayonet connection with the tool.

8. The connecting system according to claim 1, wherein on a side opposite from a recess for an engagement of a tool, the securing element has a guide.

9. The connecting system according to claim 8, wherein the guide is a pivot pin.

10. The connecting system according to claim 8, wherein the securing element has an external guide.

11. The connecting system according to

8, wherein recesses correspondingly adapted to the guide are provided in the half-spaces of the elements or modules.

12. The connecting system according to claim 1, wherein the securing element is mirror-symmetrical in relation to two axes.

13. The connecting system according to claim 1, further comprising a retaining piece, which can be inserted onto the securing element, which has been rotated into a securing position in the recess of the two half-spaces between the two elements or modules.

14. The connecting system according to claim 13, wherein the retaining piece can be inserted into the recess and/or produces a clamped securing by fitting onto or over the securing element.

15. A method for mechanically securing adjacently positioned elements or modules in a plane, in which two of the elements or modules are loosely laid directly adjacent to each other above a supporting surface, the method comprising:
inserting or introducing a securing element with an elongated cross-sectional area through an opening into a recess composed of two respective half-spaces, which are positioned flush with each other in mirror-symmetrical or point-symmetrical fashion in edge regions of the adjacent elements or modules, and then rotating the securing element in the recess by approximately 90° around an axis parallel to a surface normal to the elements or modules.

16. The connecting system according to claim 1, wherein the elements or modules are flat solar modules that are positioned above a supporting surface.

17. The connecting system according to claim 1, wherein at least one of the half-spaces has a detent lug and/or an end stop for limiting a rotation of a securing element to approximately 90°.

18. The connecting system according to claim 3, wherein the securing element has two circumferential surfaces, which constitute circumferential surface segments of a cylinder.

19. The connecting system according to claim 10, wherein the external guide is a protrusion.

20. The connecting system according to claim 14, wherein the retaining piece can be inserted into the recess and/or produces the clamped securing by fitting onto or over the securing element using a clamping groove.
